(19) United States
(12) Patent Application Publication
(10) Pub. No.: US 2023/0214441 A1
(43) Pub. Date: Jul. 6, 2023

(54) DUAL SEARCH SYSTEM

(71) Applicant: Quantum Blue, Inc., Chicago, IL (US)

(72) Inventors: David L. Newman, Evanston, IL (US); Reginald A. Holmes, Pasadena, CA (US); Kenji Toyooka, Ottawa (CA)

(21) Appl. No.: 18/086,943

(22) Filed: Dec. 22, 2022

Related U.S. Application Data
(60) Provisional application No. 63/295,660, filed on Dec. 31, 2021.

(51) Int. Cl. G06F 16/957; G06F 16/33; G06F 40/247; G06F 40/242

(52) U.S. Cl. CPC G06F 16/9577; G06F 16/3335; G06F 40/247; G06F 40/242

(57) ABSTRACT

A system for conducting a search of dual databases for conducting a dual search, where at least two databases are searched simultaneously by entering a single search term comprising a processor and a memory to store a set of instructions wherein the processor accesses the instructions to receive a search term by a program, dissect the search term into its component parts using a dictionary algorithm, form a first search term having a first format of the first search term, form a second search term with a second format of the second search term, use the first search term to search a first database and saving a first result, use the second search term to search a second database and saving a second result and combine the first and second results in a single display page.

### CROSS-REFERENCE TO RELATED APPLICATIONS

The present application claims the benefit of non-provisional application No. 63/295,660 filed Dec. 31, 2021, which priority application is fully incorporated herein by reference.

### FIELD

The present application pertains to software and systems for conducting a dual search, where at least two databases are searched simultaneously by entering a single search term.

### BACKGROUND

Searching of multiple databases is usually conducted on a non-automated basis. A user searches database 1, gets a result and then manually searches database 2 and gets a result. Database 1 requires the data to be in format A and database 2 requires the data to be in format B. So a user is required to manually alter the search request to have format A and then subsequently format B. Due to the non-automated process, such searching of dual databases can be very time consuming and human resource consuming. It is a purpose of this invention to allow for dual searching in a more automated manner.

### SUMMARY

A system for conducting a search of dual databases for conducting a dual search, where at least two databases are searched simultaneously by entering a single search term comprising a processor and a memory to store a set of instructions. Wherein the processor accesses the instructions to receive a search term by a program, dissect the search term into its component parts using a dictionary algorithm, form a first search term having a first format of the first search term, form a second search term with a second format of the second search term, use the first search term to search a first database and saving a first result. Using the second search term to search a second database and saving a second result and combine the first and second results in a single display page.

Generating a search term variations page and providing synonyms for the first or second search terms. The search term variation generation includes an interactive and iterative variation selection process. Using a thesaurus to promulgate variations and ranking the variations. Providing a domain name database as the first database. Providing a trademark database as the second database. Displaying the search results in a first column providing domain name alternatives and a second column providing trademark alternatives. Ranking the search results and ranking the search results from 1 to 20.

A computer system is provided comprising a processor and a memory to store a set of instructions. Wherein the processor accesses the instructions to conduct a search of dual databases comprising the steps of entering a search term to a program, dissecting the search term into its component parts using a dictionary algorithm, forming a first search term having a first format, forming a second search term having a second format, using the first search term to search a first database and saving a first result, using the second search term to search a second database and saving a second result and combining the first and second results in a single display page.

Omitting spaces between alphanumeric symbols of the first search term. Inserting a space between alphanumeric symbols of the second search term. Omitting spaces between alphanumeric symbols of the first search term to form the first format. Inserting a space between alphanumeric symbols of the second search term to form the second format. Wherein the first format is prescribed by ICAAN domain name formatting protocol. Wherein the second format is prescribed by the USPTO trademark formatting protocol. Omitting spacing between all alphanumerics and inserting a top level domain name suffix. Using a dictionary app to break the second search term down to morphemes and

inserting a space between each morpheme to establish the search the USPTO trademark database. Searching a database comprising one of the following subject matters: airline reservations, hotel reservations, lodging reservations, theatre reservations, stock exchange pricing, dining reservations, social networks, library, real estate listings, automobile records and dating sites. Wherein the first database is an automobile title database and the second database is a storm surge location database to determine the likelihood that an automobile has water damage.

### BRIEF DESCRIPTION OF THE DRAWINGS

FIG. 1 is a flow diagram of a dual searching system;

FIG. 2 is a flow diagram of a dual searching system in another embodiment;

FIG. 3 is a template of a screen shot depicting dual search results;

FIG. 4 is a screen shot depicting dual search results in another embodiment; and

FIG. 5 is a block diagram of a computer system for a dual searching process.

### DETAILED DESCRIPTION

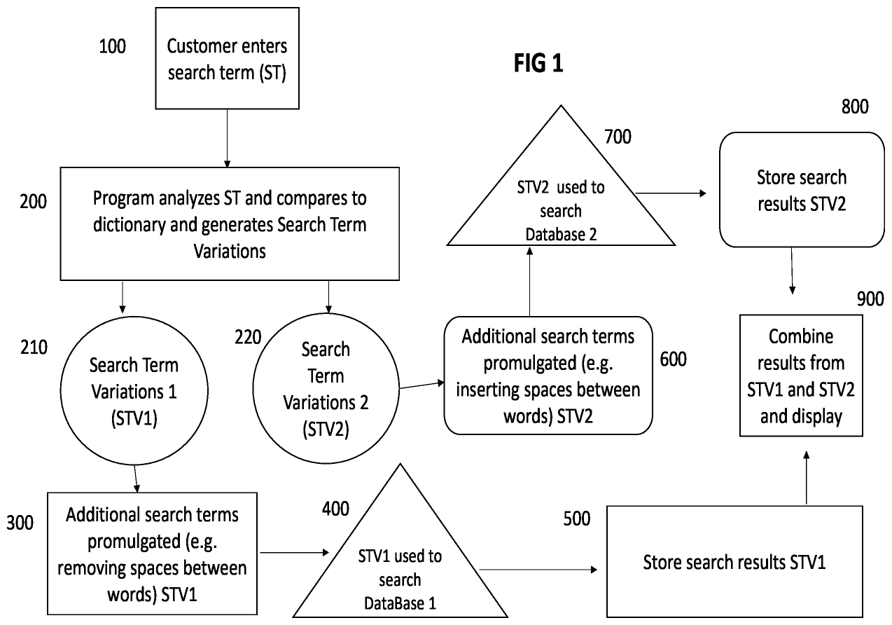

FIGS. 1-5 depict embodiments of the present invention. As an overview, subsequent to entering the search term, modifications for the first database are made and search term variation 1 (STV1) is searched in database 1. Simultaneously STV2 is created and searched in database 2. Following the returning of the search results from STV1 and STV2, the system uses an algorithm to create alternate search results.

Turning to FIG. 1, a flow diagram depicts an embodiment of the invention. A system for conducting a search of dual databases comprises the step 100 of entering the search term (ST) to the program (e.g. API, software, network or computer system). At step 200, the ST is dissected and analyzed in preparation to submitting to Database 1. For example, the search term (ST) may need to be modified to comport with the input parameters of Database 1. In an embodiment, the ST is separated into its component parts using a dictionary algorithm to form search term variation 1 (STV1) at step 210. At step 300, forming a first search term without spaces in STV1 is promulgated. Simultaneously at step 220, search term variation 2 (STV2) is formed and at step 600 a second search term with spaces is formed STV2. It is to be understood that a search term my be alphanumeric, all numerals, all letters or a combination of both and using dashes, @, #, &, *, / or any other symbol or punctuation.

In an embodiment, if the user types in the search term with spaces between syllables, the default is for the program to automatically remove the spaces for a domain name search and to do a trademark search with spaces. In an embodiment the domain name search will include: .com, .net, .biz, .edu, .gov, .org and others.

For STV1 at step 400, the first search term is used to search a first database and at step 500 saving a first result for STV1 is stored. At the same time for STV2, using the second search term at step 700 database 2 is searched and at step 800 a second result based on STV2 is stored. Finally, at step 900 the two search results for STV1 and STV2 are displayed in combination on a single display. It is to be understood that the present invention may be applied for any number of search terms greater than two, so that STV3, STV4, STVn are to be modified and displayed in coordination with searches of databases 3, 4, n.

In an embodiment, Database 1 may be a domain name database for assigning URLs to individuals or companies to use as a web address. In an embodiment, Database 2 may be a trademark database for a government of a country where registered trademarks are stored. In an embodiment, Database 1 and 2 are searched simultaneously to determine whether a search term (e.g brand name) is available both as a domain name and a trademark for usage by a new business or new product offering.

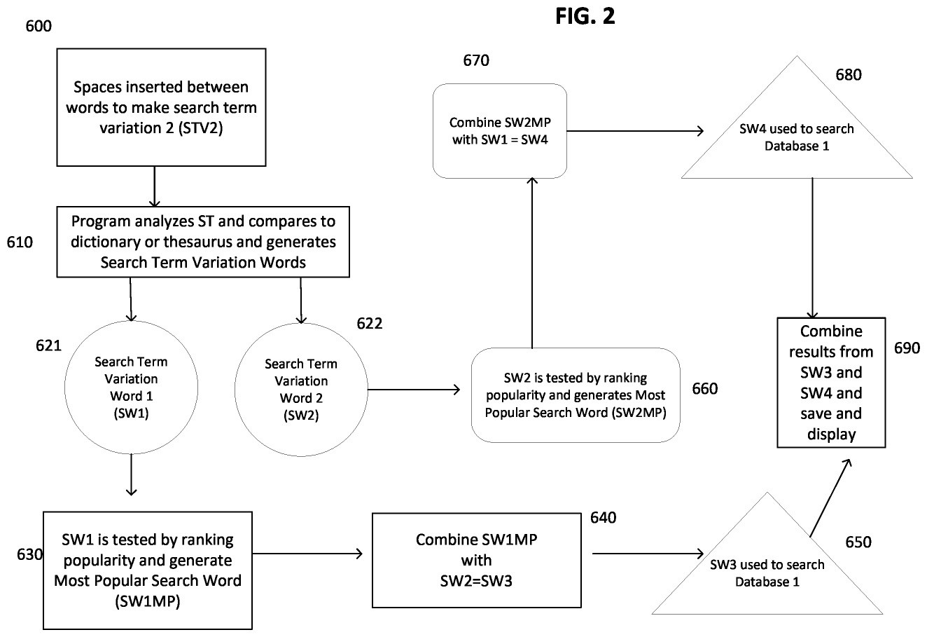

Additional details of the searching and variations of the search term are described with respect to FIG. 2. The program receives a search request 600 with multiple words. For example, the search term variation 2 (STV2) may have spaces, dashes and multiple words: “red” “sky” “tech-consulting.” At step 610 the computer program analyzes STV2 and compares it to resources (e.g. dictionary, thesaurus, etc.) and generates search term variation words. At steps 621, 622 the text is split into discrete words (e.g. search term variation word 1 and 2) SW1 and SW2. At step 630, SW1 is tested and ranked and assigned points (e.g. based on popularity, trends, usage etc.) to generate the most popular search word (SW1MP). For example, “red”=5, “sky”=10, “tech”=5, “consulting”. Then at step 630 words in the search term are replaced depending on the words or points (e.g. “red” is replaced by taking first term and run thru database of synonyms). For example, use (thesaurus.com) (thesaurus API) to generate new search word: “crimson.”

Turning to step 640 the SW1MP is combined with SW2 to make search word 3 (SW3). At step 650 database 1 is searched using SW3 and the results from SW3 and other search terms (SW4) is saved and displayed in combination at step 690. Likewise at step 660 ranking and popularity is determined to make most popular search word (SW2MP). Then at step 670 SW2MP is combined with SW1 to make and new search word SW4. Finally at step 680, SW4 is searched in database 1 and the results are combined at step 690. In another embodiment, SW4 may be searched in database 2.

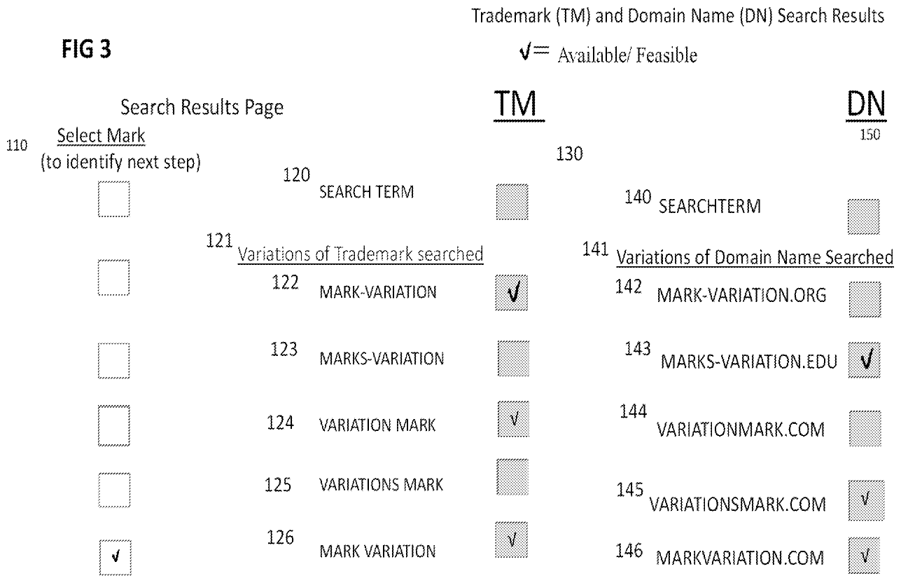

An API can be used to determine ranking of synonyms by determining popularity of a term at step 622. For example, use trends.google.com/searchterm (Google Trends) to substitute “web solutions” for “tech-consulting”. At step 670 the words are recombined to make a new search term alternative: “crimson sky web solutions.” At step 660 a rating of the quality or availability of the search term text is made. For example, the program may assign points to each word based on popularity, popular pairings or uniqueness. At step 660 by ranking and assigning points the search term can be assigned a level of interest and a “keep” or “discard” decision made accordingly. For example, by taking the top 5 words to make new search term and running through domain name Database 1 and then trademark Database 2 to check availability. Then repeat for all 5 words/terms to obtain “crimson”=30, “sky”=10, “web”=15 and “solutions”=35 a user may discard the search term and return to step 610, or keep the search term and progress to step 680. At step 690 the search term is added to suggestion/alternatives list of variations from the original search term. The process is repeated until a satisfactory number of alternative suggestions is listed (e.g. 20). Finally at step 690, the list of 20 alternatives is output as a suggestion list (see FIG. 3). In an embodiment the list by be ordered or ranked using the points assigned previously in step630 or 660. If the list of suggestions has less than 20 on the list then the program returns to step 610 to generate more alternative search terms (e.g. substituting “scarlet” for “crimson”).

The invention may be used to find, in an embodiment, a brand name to be used for both a domain name and a trademark. Upon typing in the proposed search term in a search bar, and selecting enter, the search term is analyzed using a search term generator/dictionary function to develop alternate/variations in search terms. In addition to the above algorithm steps, the following may be undertaken with each search term: may be split-up with spaces in between each syllable, have the following added at the end of the word: “S,” “ES,” “ED,” “ING,” “IES” and at the beginning of the word: “GO” and “YOUR”. Each of these variations may be looked up in a dictionary to see if the new word is present. If so, then each of the variations is searched in the domain name/ICANN database and a trademark database.

In the above embodiment, steps are automated and the program can make decisions based on ranking/points assigned to each new word or search term. In an alternate embodiment, some of the steps will require user input to select the next word/search term to be analyzed. Such an iterative search that takes user input at various steps will result in a highly customized and unique search term result. Through interaction between the program and the user, a highly customized process is enabled where the user feels part of the creation of new search terms to invent new search terms/brand names. For example, the user may select a synonym from a list of synonyms to create a new search term. That new word is combined with other text to generate a new search term. In another embodiment, the system may be a place for user input to decide whether to “keep” or “discard” the text for the search term in order to establish a user directed, iterative search term selection process. As shown above, the system provides an automated curation process for selecting a brand name.

Turning to FIG. 3, a sample search results page is depicted. In the embodiment depicted for conducting a dual search the example provided is for searching domain names (DN) and trademarks (TM). In this embodiment, Database 1 is the ICANN domain name database and Database 2 is the USPTO trademark electronic application system (TEAS). As shown “search term” 120 has a space inserted when searching the TM database and “searchterm” 140 has the space omitted to search the DN database. As a result of the dual search being conducted the checkbox under TM 130 is unchecked and the checkbox under DN 150 is unchecked. So the display indicates that both the trademark and domain name are unavailable for the particular search term that was searched. As shown in FIG. 2, if there are no hits (no equivalent trademarks or domain names) then the program provides variations on the entered search term and a check mark is ticked for each variation of the search term/mark searched. Upon conducting a dual search, if there are no “hits” than a search term may be listed as “available” or “feasible” in Database 1 or 2, or both.

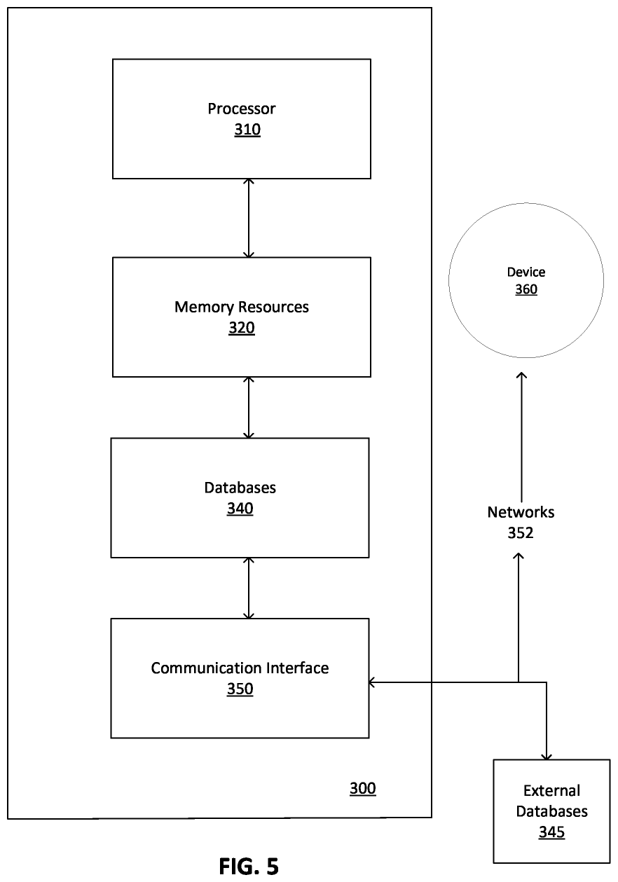

As discussed above, search term variations may be automatically generated or generated through an interactive process, but in either case the variations may be searched through the trademark database and domain name database 340 (FIG. 5). As shown in FIG. 3, the trademark variations search is undertaken using the following search terms: “mark-variation” 122, “marks-variation” 123, “variation mark” 124, “variations mark” 125 and “mark variation”. After conducting the trademark search 121, the results are a finding of “availability” or “feasible” for “mark-variation” 122, “variation mark” 124 and “mark variation” 126. (It is understood that for a complete trademark to be cleared for “availability” the goods and services and other factors must be considered).

The domain name variations search 141 is undertaken using the following search terms: “marks-variations.org” 142, “marks-variation.edu” 143, “variationmark.com” 144, “variationsmark.com” 145 and “markvariation.com” 146. After conducting a search of the DN database the results are “availability” for “marks-variation.edu” 143, “variationsmark.com” 145 and “markvariation.com” 146.

The user may select a variation term by checking a checkbox from column 110 in order to move to the next step (e.g. purchase a domain name or trademark). In the example provided, the last check box 110 is selected since the search term “mark variation” 126 and “markvariation.com” 146 is available.

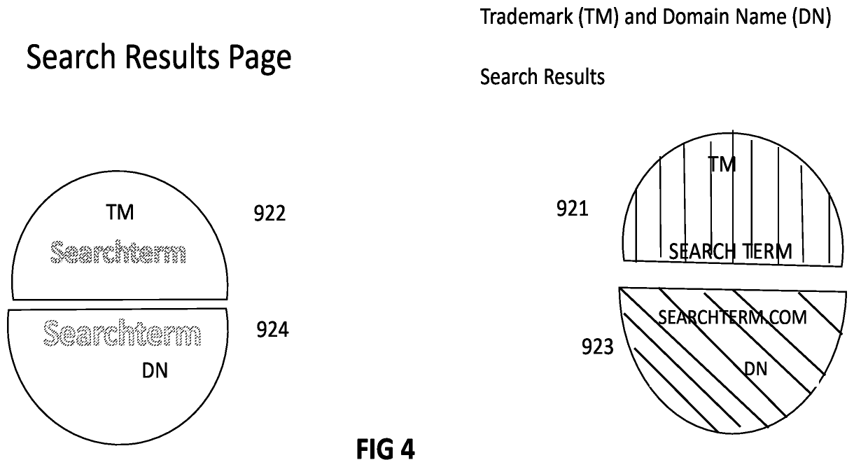

Turning to FIG. 4 an alternative for displaying search results is shown. The use of a circle as a graphic representation of the search results is desirable when the circle may be cut into pieces that are representative of the availability of a TM and/or DN. For example, following a search where it is determined that “searchterm” is available as a TM, upper circle half is displayed in green 922, and lower circle half is displayed in green 924, indicating that the DN is available. In another embodiment, the circle halves may be shaded red to indicate that the TM and DN are not available. In a further embodiment, if four search terms results are to be displayed, the circle may be sliced into four quadrants with a different color in each quadrant to represent “availability,” “likely available,” “feasible” and “not available.”

In a further embodiment, the search term results may be displayed with cross-hatching designating availability or non-availability. So the vertical cross-hatching in circle half 921 indicates that “search term” is an available trademark and angled cross-hatching in circle half 923 indicates that “searchterm.com” is an available domain name. It is to be understood that different geometric shapes may be used and different colors or cross-hatching may be used.

FIG. 5 is a block diagram that illustrates a computer system 300 upon which embodiments described herein may be implemented. A computer system 300 can be implemented on, for example, a server or combination of servers 300. For example, the computer system 300 may be implemented as part of a network service for providing searching services. In the context of FIG. 1, some or all of the functionality described with a dual search system may be implemented using computer system and server 300. Likewise, a method such as described with an example of FIGS. 2-4 may also be implemented using computer system and server 300.

In one implementation, the computer system and server include processing resources, memory resources 320 (e.g., read-only memory (ROM) or random access memory (RAM)), databases 340 and a communication interface 350. The computer system includes at least one processor 310 to process information (including storing temporary variables) and execute instructions stored in the memory resources. The computer system may also include additional storage devices for storing static information and instructions for the processor 310. A storage device such as a magnetic disk or optical disk for storing information and instructions is provided.

The communication interface 350 enables the computer system to communicate with one or more client devices 360, over one or more networks (e.g., cellular network) 352 through use of the network link (wireless or a wire). The communication interface may also communicate with external databases 345. In particular, the computer system 300 may use memory resources to store executable instructions that can be executed on the computer system to configure browsers and/or browser-enabled applications of respective client devices 360, in order to implement functionality such as described with a server 300 of an example of FIGS. 1-4. As an addition or variation, the computer system may transfer scripts, browser logic, plugins or other instructions to client computers in order to enable a distributed computing platform on which page rendering functionality such as described with an example of FIGS. 1-4 may be provided.

Examples described herein are related to the use of the computer system for implementing the techniques described herein. According to an aspect, techniques are performed by the computer system in response to the processor 310 executing one or more sequences of one or more instructions contained in the memory resources 320. Such instructions may be read into the memory resources from another machine-readable medium, such as the storage device. Execution of the sequences of instructions contained in the memory resources may cause the processor 310 to perform the process steps described herein. In alternative implementations, hard-wired circuitry may be used in place of or in combination with software.

What is claimed is:

1. A system for conducting a search of dual databases for conducting a dual search, where at least two databases are searched simultaneously by entering a single search term comprising:
a processor;
a memory to store a set of instructions wherein the processor accesses the instructions to:
receive a search term by a program;
dissect the search term into its component parts using a dictionary algorithm;
form a first search term having a first format of the first search term;
form a second search term with a second format of the second search term;
use the first search term to search a first database and saving a first result;
use the second search term to search a second database and saving a second result; and
combine the first and second results in a single display page.

2. The system of claim 1, further comprising the step of generating a search term variations page and providing synonyms for the first or second search terms.

3. The system of claim 2, wherein the search term variation generation includes an interactive and iterative variation selection process.

4. The system of claim 1, further comprising the step of using a thesaurus to promulgate variations and ranking the variations.

5. The system of claim 1, further comprising the step of providing a domain name database as the first database.

6. The system of claim 1, further comprising the step of providing a trademark database as the second database.

7. The system of claim 1, further comprising the step of displaying the search results in a first column providing domain name alternatives and a second column providing trademark alternatives.

8. The system of claim 1, further comprising the step of ranking the search results.

9. The system of claim 1, further comprising the step of ranking the search results from 1 to 20.

10. A computer system comprising:
a processor;
a memory to store a set of instructions wherein the processor accesses the instructions to:
conduct a search of dual databases comprising the steps of:
entering a search term to a program;
dissecting the search term into its component parts using a dictionary algorithm;
forming a first search term having a first format;
forming a second search term having a second format;
using the first search term to search a first database and saving a first result;
using the second search term to search a second database and saving a second result; and
combining the first and second results in a single display page.

11. The system of claim 10, further comprising the step of omitting spaces between alphanumeric symbols of the first search term.

12. The system of claim 10, further comprising the step of inserting a space between alphanumeric symbols of the second search term.

13. The system of claim 10, further comprising the step of omitting spaces between alphanumeric symbols of the first search term to form the first format.

14. The system of claim 10, further comprising the step of inserting a space between alphanumeric symbols of the second search term to form the second format.

15. The system of claim 10, wherein the first format is prescribed by ICAAN domain name formatting protocol.

16. The system of claim 10, wherein the second format is prescribed by the USPTO trademark formatting protocol.

17. The system of claim 15, further comprising the step of omitting spacing between all alphanumerics and inserting a top level domain name suffix.

18. The system of claim 16, further comprising the steps of:
using a dictionary app to break the second search term down to morphemes; and
inserting a space between each morpheme to establish the search the USPTO trademark database.

19. The system of claim 10, further comprising the step of searching a database comprising one of the following subject matters:
airline reservations, hotel reservations, lodging reservations, theatre reservations, stock exchange pricing, dining reservations, social networks, library, real estate listings, automobile, dating sites, weather events, product safety ratings and travel warnings.

20. The system of claim 10 wherein the first database is an automobile title database and the second database is a storm surge location database to determine the likelihood that an automobile has water damage.
